(19) United States
(12) Patent Application Publication
(10) Pub. No.: US 2002/0088406 A1
(43) Pub. Date: Jul. 11, 2002

(54) PYP (pamper your pooch) bowl-canine commode

(76) Inventor: Artrice Lee Norwood, Detroit, MI (US)

Correspondence Address: Artrice L. Norwood, West Tower Apartment # 2104, 1321 Orleans, Detroit, MI, 48207, US

(21) Appl. No.: 09/747,539

(22) Filed: Dec. 21, 2000

(51) Int. Cl. A01K 29/00

(52) U.S. Cl. 119/161

(57) ABSTRACT

An innovative 21^{st} Century solution for canine waste elimination and disposal. The PYP Bowl-Canine Commode is a mold of a commode bowl with urinal wall for canine waste elimination and disposal of waste by means of a septic system. The canine commode bowl and urinal wall is of sufficient size to accommodate use by canines. The PYP Bowl-Canine Commode can be installed in a basement, a restroom, or other designated area. As with house training, a canine is trained to prompt its owner to allow its use of The PYP Bowl-Canine Commode, versus going outdoors in adverse weather conditions and at inconvenient times for its owner. Additionally, The PYP Bowl-Canine Commode minimizes indoor and outdoor retrieval of canine waste.

### REFERENCE TO SEQUENCE LISTING, A TABLE, OR A COMPUTER PROGRAM LISTING APPENDIX

Not applicable.

### BACKGROUND OF THE INVENTION

This invention relates to an innovative 21^{st} Century means by which to pamper your pooch and dispose of canine waste elimination.

### BRIEF SUMMARY OF THE INVENTION

The PYP (Pamper Your Pooch) Bowl-Canine Commode is a mold of a commode bowl with urinal wall inset for canine waste elimination and disposal. The PYP Bowl-Canine Commode will minimize indoor and outdoor retrieval of canine waste.

### BRIEF DESCRIPTION OF THE DRAWINGS

FIG. 1 is a primary view of my invention and it represents the basic structure of The PYP Bowl-Canine Commode with urinal wall inset.

FIG. 2 is a perspective view of a mold of The PYP Bowl-Canine Commode with urinal wall inset.

FIG. 3 is a view of the encasement of The PYP Bowl-Canine Commode depicting portholes for inset of a commode bowl with urinal wall.

FIG. 4 represents an encased mold of The PYP Bowl-Canine Commode with urinal wall inset.

### DETAILED DESCRIPTION

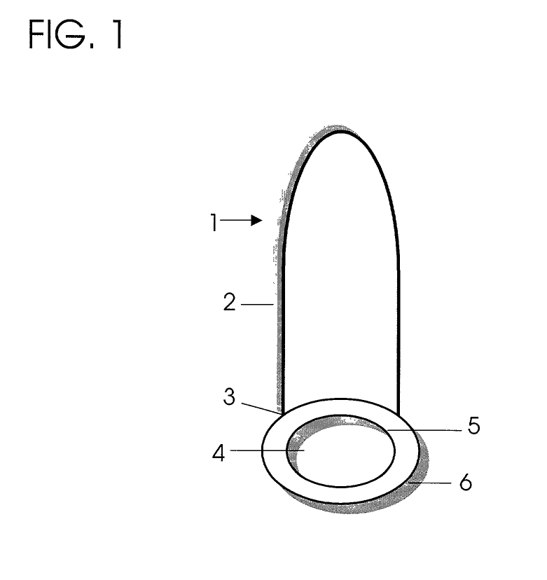

A primary view of The PYP Bowl-Canine Commode is shown in FIG. 1. The reference number 1 shows the basic structure of the mold for a canine commode bowl with urinal wall inset. The canine commode bowl with urinal wall inset is of sufficient size to accommodate use by a canine. The incurved urinal wall inset shown in number 2 has a urinal ditch extending into the concave of the canine commode bowl as shown in numbers 3 and 4, respectively. The interior of the annulus shown in number 5 will provide for bowl water recovery when the septic tank is flushed. The reference number 6 depicts the exterior of the canine commode bowl.

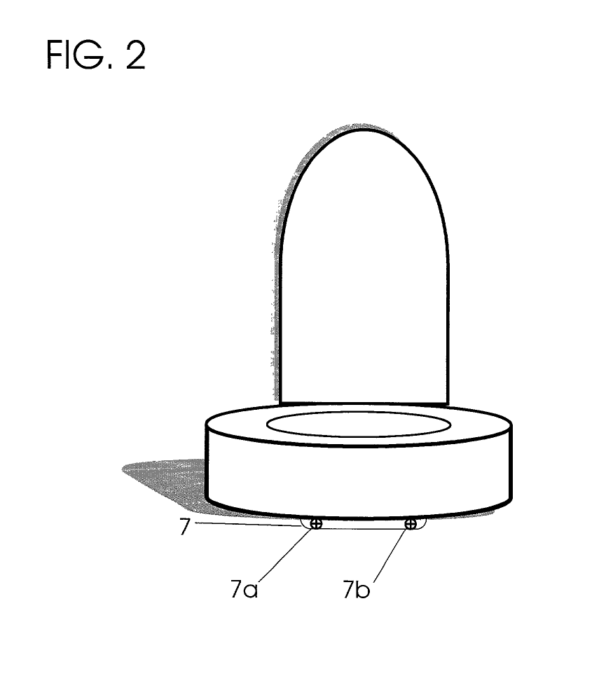

A perspective view of The PYP Bowl-Canine Commode, as shown in FIG. 2, shows a refined diagram of the mold structure for a canine commode bowl with urinal wall inset. The mounting base and mounting bolts for the canine commode bowl is represented by reference numbers 7, 7a, and 7b, respectively.

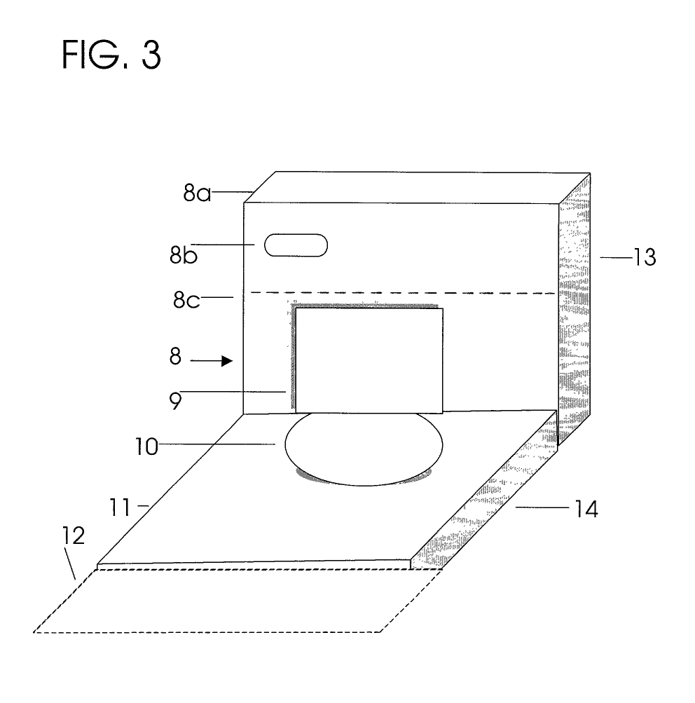

A structural view of the encasement of The PYP Bowl-Canine Commode, is shown in FIG. 3. The reference number 8 shows allowance for encasement of septic tank. Reference numbers 8a, 8b, and 8c, show septic tank lid placement, flush lever inset, and septic tank base level, respectively. A porthole for a urinal wall inset is shown in number 9 and a porthole for a canine commode bowl inset is shown in number 10.

The canine commode bowl encasement as shown in number 11, serves as a pedestal allowing canine access to the commode bowl and urinal wall inset. Additionally, the elevation of the encasement produces allowance for height of the canine commode bowl to accommodate bowl water level. An incline as shown in number 12, will allow the canine to board the pedestal. Reference numbers 13 and 14 show the approximate locations for a septic system.

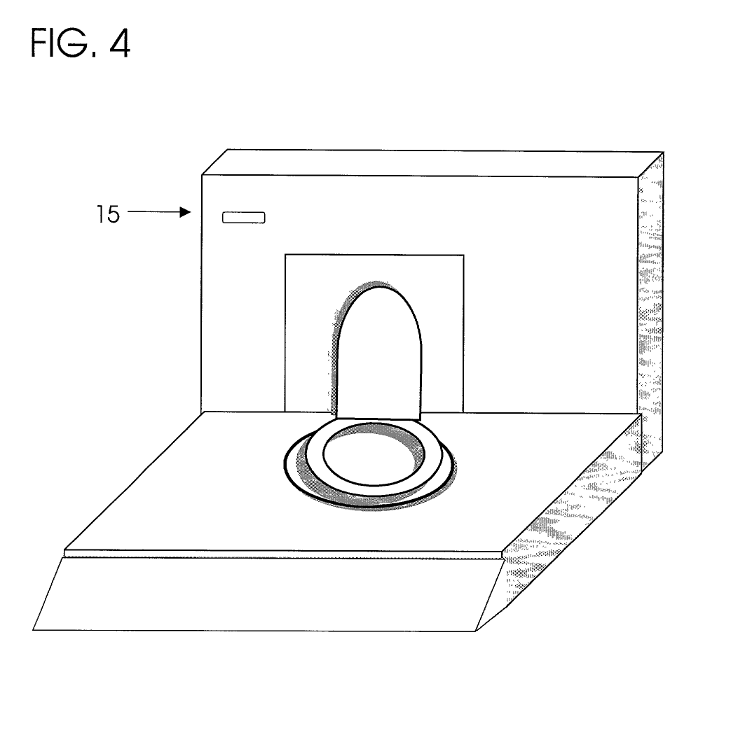

FIG. 4 depicts a structural view of a stationary, one-piece, porcelain mold of a canine commode bowl with urinal wall inset as indicated in number 15.

1. I, Artrice L. Norwood, claim the invention of a canine commode bowl with urinal for canine waste elimination, comprising:
(a) a commode bowl of sufficient size to accommodate use by a canine, with urinal of sufficient size to accommodate use by a canine,
(b) whereby said commode bowl with urinal can be used by said canine for waste elimination, and
(c) whereby disposal of said waste can be flushed by means of a septic system.
